(19) United States
(12) Patent Application Publication
(10) Pub. No.: US 2021/0271224 A1
(43) Pub. Date: Sep. 2, 2021

(54) CLOUD REAL-TIME TEXTILE INTELLIGENT PRODUCTION INFORMATION MANAGEMENT MONITORING AND PREWARNING INTEGRATED SYSTEM

(71) Applicants: I-MIN LIN, TAINAN (TW); YU-CHENG HUANG, KAOHSIUNG (TW); MING-WANG LIN, KAOHSIUNG (TW); SHIH-CHEH SUNG, KAOHSIUNG (TW); YU-HSIANG SU, TAINAN (TW)

(72) Inventors: I-MIN LIN, TAINAN (TW); YU-CHENG HUANG, KAOHSIUNG (TW); MING-WANG LIN, KAOHSIUNG (TW); SHIH-CHEH SUNG, KAOHSIUNG (TW); YU-HSIANG SU, TAINAN (TW)

(21) Appl. No.: 16/803,695

(22) Filed: Feb. 27, 2020

(51) Int. Cl. G05B 19/4063; G05B 19/18

(52) U.S. Cl. CPC G05B 19/4063; G05B 2219/31439; G05B 19/182

(57) ABSTRACT

The present invention relates generally to a Cloud real-time textile intelligent production information management monitoring and prewarning integrated system, which comprises a sensing device, a communication system, a server, a central information integration system and an end device. The sensing device is installed on textile automation equipments to sense the real-time state information of the textile automation equipments and connected to the communication system, and the communication system sends the real-time state information to the server, it is connected to the central information integration system, so that the real-time status can be monitored at any time to check whether it exceeds the set value to give a warning message which is displayed on the end device, forming a Cloud real-time textile intelligent production information management monitoring and prewarning integrated system for real-time monitoring of overall manufacturing process of mills, increasing the manufacturing efficiency and reducing losses greatly.

### BACKGROUND OF INVENTION

The present invention relates generally to an automatic production information management system for textile industry, and more particularly to a Cloud real-time textile intelligent production information management monitoring and prewarning integrated system integrated with a machine automatic sensing device, a communication system, a server, a central information integration system and an end device for real-time monitoring and prewarning.

### 2. DESCRIPTION OF RELATED ART

With rapid development of information technology and advancement of industrial automation, many industries have stepped into automated production gradually. Our industry was characterized by processing intensive export in the early stages. The productive efficiency of traditional manufacturing industry is highly praised in the world. Therefore, in order to enhance international competitiveness, many industries joined automated production in succession, but some processes could not be linked with each other, resulting in considerable gaps in production flow or management system. Especially when the automated production is admitted to textile industry, sometimes the processes cannot be connected or there are errors in automated production which cannot be monitored or handled in time, leading to production schedule delay or product deficiencies. Therefore, how to increase the productive efficiency and monitor the automated production process effectively becomes an important and urgent topic to the manufacturers of textile industry.

At present, the textile industry mostly uses single production automation process for production, including weaving, dyeing, hot water recovery, shrinking, drying and effluent testing procedures, the single production automation process can be displayed by PLC or computer information system on the end device, the supervisor must perform monitoring and analysis in the production field or by multiple online mode, the overall process cannot be identified immediately. Related manufacturers have developed a system for detection and remote management of sensors installed on one or more textile machines and/or fabric and/or metal yarn feeding devices, the textile machine is equipped with an electronic control unit electrically connected to the sensor, a first communication component and a second wireless communication component operatively correlated with the electronic control unit and a portable electronic device with a display interface component, so that the system enables a single operator to obtain the immediate information of one or multiple textile machines installed in the mill.

Therefore, how to install sensing devices on different textile automation equipments and integrate communication system, server, central information integration system and end device to form a Cloud real-time textile intelligent production information management monitoring and prewarning integrated system for real-time monitoring of the overall manufacturing process of the mill to increase the manufacturing efficiency and reduce losses greatly becomes an urgent and important topic for the inventor of this project.

### SUMMARY OF THE INVENTION

Therefore, in the implementation spirit of careful study and creation, based on the aforesaid technical problems, this inventor started research and development. With years' professional practice of creation and what learned from implementation, the inventor concentrated on research and development and put forth new ideas, so as to propose the present invention, hoping to enhance the advantages of this product and to remedy the known defects.

The main object of the present invention is to provide a Cloud real-time textile intelligent production information management monitoring and prewarning integrated system integrated with a plurality of sensing devices, a plurality of communication systems, a server, a central information integration system and an end device, so as to monitor the textile production process instantly and increase the manufacturing efficiency, the losses can be reduced greatly, and corrections can be proposed instantly.

Another object of the present invention is to provide a Cloud integrated system, integrating the overall processes in the textile mill into a central information integration system, so as to form a Cloud real-time textile intelligent production information management monitoring and prewarning integrated system for optimizing the efficiency of production flow and increasing the working efficiency of personnel.

The third object of the present invention is to provide an information integration process design and adjustment for real-time, rapid and effective management of the overall production flow structure of textile mills, and for integrating the upstream and downstream, the communication processes among departments can be reduced greatly, and the competitiveness of products in the industry can be enhanced effectively.

To attain said objects, the Cloud real-time textile intelligent production information management monitoring and prewarning integrated system of the present invention comprises a plurality of sensing devices, a plurality of communication systems, at least a server, a central information integration system and an end device. The plurality of sensing devices are installed on the textile automation equipments, so that the real-time state information of the textile automation equipments can be detected instantly and connected to the plurality of communication systems, and to the server via the communication systems, so that the real-time state information can be immediately sent to the server, and the information of various textile automation equipments can be instantly sent via the client-side connected to the server to the central information integration system for analytical judgment to check whether it exceeds the set value to decide whether or not to give a warning signal, and it is displayed on the end device.

Preferably, the plurality of sensing devices include a production equipment sensing device, a dyeing equipment sensing device, a recovery sensing device and an effluent sensing device, the relevant information of textile automation equipments can be sensed instantly and reported to the central information integration system instantly.

Preferably, the data acquisition monitoring system is connected to the Cloud database, comprising a remote office system, a production control system, a weaving command information system, a production preparation order monitoring system, a quantity detail monitoring system, a false twist extension monitoring system, a dyeing monitoring system, a water quality monitoring system and a quality monitoring management system, so that the data acquisition monitoring system can collect and judge different kinds of textile real-time state information instantly, a warning signal will be sent to the end device if the set value is exceeded, and the real-time state information is stored in the Cloud database.

Therefore, the present invention endues the Cloud real-time textile intelligent production information management monitoring and prewarning integrated system with real-time monitoring, real-time correction, lower process communication cost and less production error probability, so as to increase the operators' working efficiency and reduce personnel and marketing costs, described below:
(1) The integrated textile automation equipment information system sends the production information to the central information integration system effectively, so that the managerial staff can monitor and analyze the condition of production line instantly, publish information effectively and rapidly and make corrections, the overall operating efficiency is increased greatly.
(2) The plurality of sensing devices installed on the textile automation equipments send real-time information to the central information integration system for analytical judgment, so as to implement immediate corrections and quick responses, and to reduce the labor cost of site operation personnel greatly.
(3) After system integration, the managerial staff and operators can obtain the required information instantly and respond quickly according to different permissions, and the process efficiency is increased greatly by integrating production, process and monitoring management, the communication cost is reduced effectively and the production error variance is reduced.

### BRIEF DESCRIPTION OF THE DRAWING

FIG. 1: Flow diagram of Cloud real-time textile intelligent production information management monitoring and prewarning integrated system of the present invention.

FIG. 2: Schematic diagram of system state in the embodiment of Cloud real-time textile intelligent production information management monitoring and prewarning integrated system of the present invention.

FIG. 3: Flow diagram of equipments and systems of Cloud real-time textile intelligent production information management monitoring and prewarning integrated system of the present invention.

### DETAILED DESCRIPTION OF THE INVENTION

To further clarify the purposes, technical proposal and advantages of the present invention, the present invention is elaborated by specific implementation method, but the aforesaid creation content is not limited to the following embodiments. Without deviating from the aforesaid technical ideas of the present invention, according to common technical knowledge and means of this field, different replacements and alterations shall be covered in the scope of the present invention.

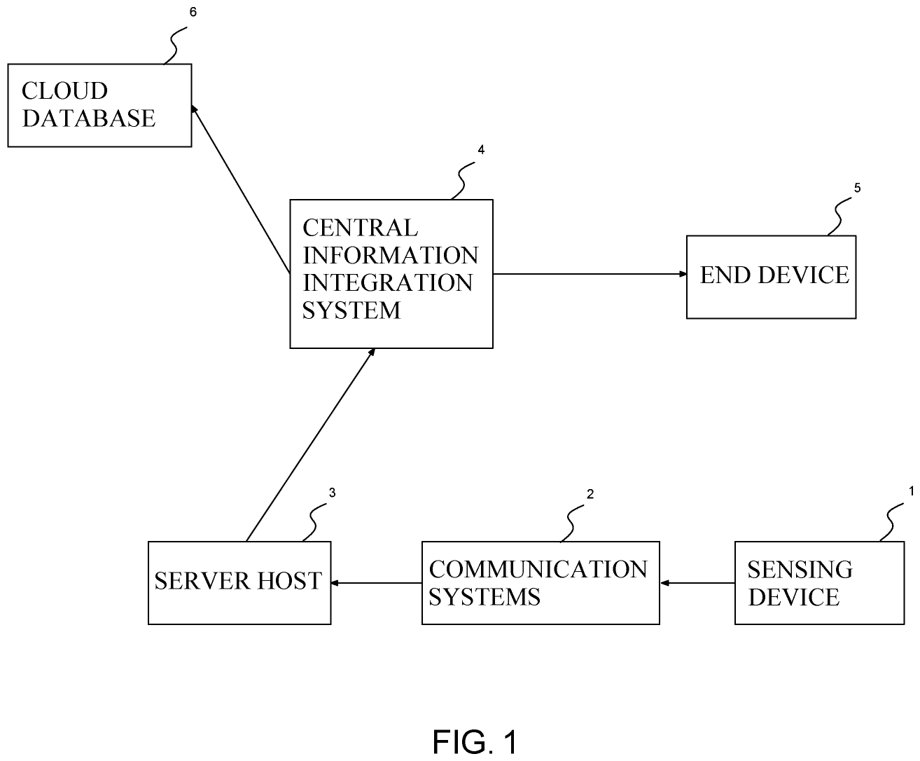

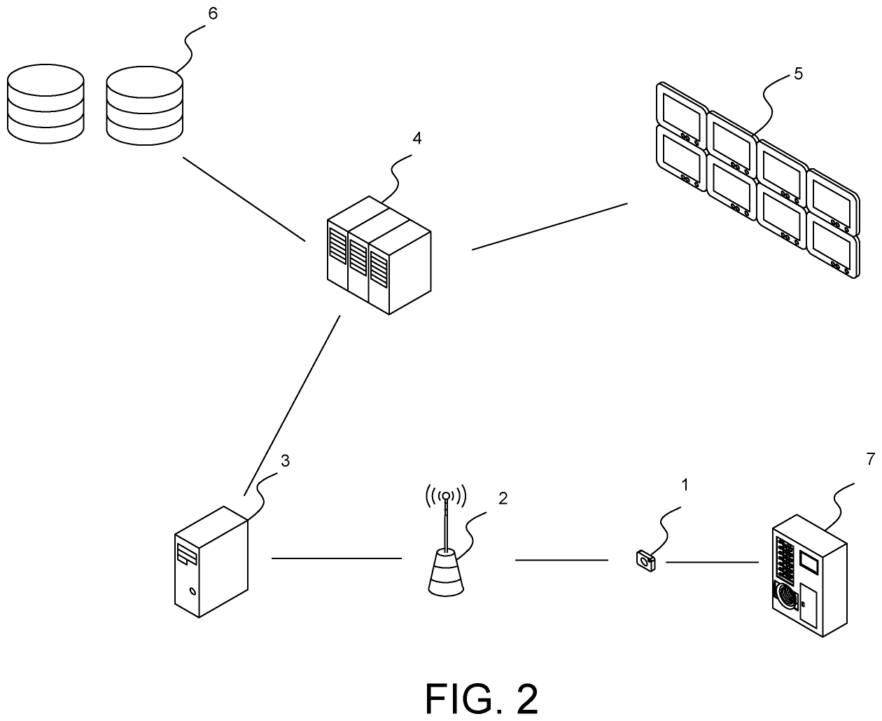

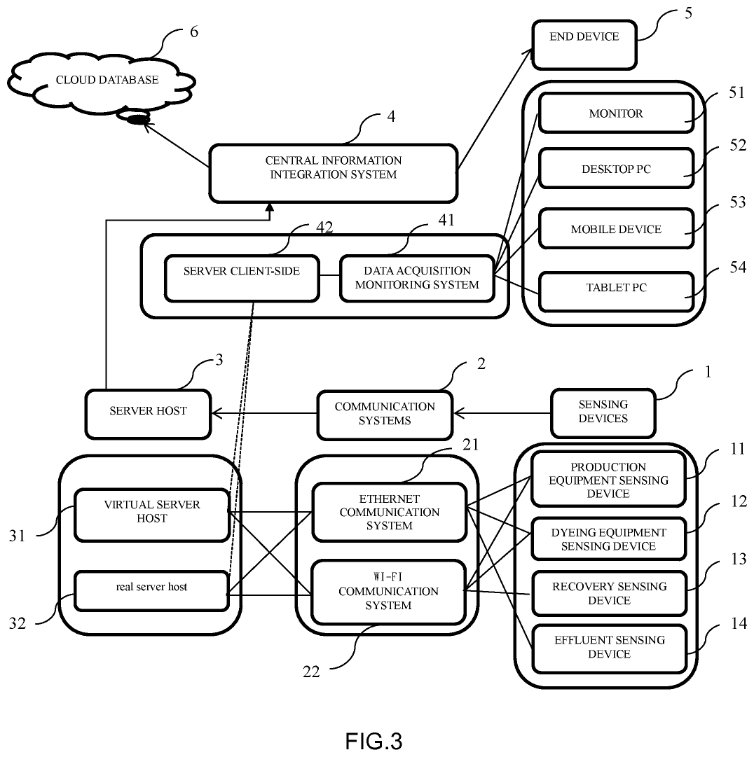

The present invention relates generally to a “Cloud real-time textile intelligent production information management monitoring and prewarning integrated system”, please refer to FIG. 1 to FIG. 3 for the flow diagram, system state diagram and equipment system flow diagram of the Cloud real-time textile intelligent production information management monitoring and prewarning integrated system of the present invention. The Cloud real-time textile intelligent production information management monitoring and prewarning integrated system of the present invention comprises a plurality of sensing devices (1), a plurality of communication systems (2), at least a server host (3), a central information integration system (4), a Cloud database (6) and at least an end device (5). Wherein the sensing device (1) is installed on a textile automation equipment (7), comprising a production equipment sensing device (11), a dyeing equipment sensing device (12), a recovery sensing device (13) and an effluent sensing device (14). The communication system (2) comprises an Ethernet communication system (21) and a Wi-Fi communication system (22). The server host (3) comprises a virtual server host (31) and a real server host (32). The central information integration system (4) comprises a data acquisition monitoring system (41) and a server client-side (42). The end device (5) comprises a monitor (51), a desktop PC (52), a mobile device (53) and a tablet PC (54). Wherein the production equipment sensing device (11) is installed on the textile automation production equipment, including a loom sensing device, which can be installed on the automatic loom, the real-time status of the automatic loom can be monitored at any time, the production history of fabric or raw material and any lack of materials can be judged immediately. The dyeing equipment sensing device (12) is installed on the textile automation dyeing equipment, including a dyeing sensing device, which is installed on the automatic dyeing machine, the real-time status of the automatic dyeing machine can be monitored at any time to decide whether or not to adjust or change the dyeing program; a shrinking sensing device, which is installed on the automatic shrinking machine, the real-time status of the automatic shrinking machine can be monitored at any time to decide whether or not to adjust the shrinking process; a drying sensing device, which is installed on the automatic dryer, the real-time status of the automatic dryer can be monitored at any time to decide whether or not to adjust the drying process, and to check whether there are abnormal conditions instantly. The recovery sensing device (13) can be installed on the hot water recovery equipment and photoelectric switch, the real-time status of hot water recovery after dyeing can be monitored at any time, so as to decide whether or not to adjust the hot water recovery related mechanism, to switch on or off the hot water recovery equipment. The effluent sensing device (14) is installed on the effluent treatment equipment, it can detect the real-time state information of the textile effluent treatment equipment, so as to monitor and adjust the effluent flow and related values at any time to adjust the effluent treatment agent or microbes, so that the real-time state information of the textile automation equipments (7) can be detected instantly and connected to the communication systems (2). Wherein the communication systems (2) include an Ethernet communication system (21) and a Wi-Fi communication system (22), and the communication systems (2) are connected to a virtual server host (31) or a real server host (32), so that the real-time state information can be immediately sent to the server host (3), and the information of textile automation equipments (7) is instantly sent via the server client-side (42) to the central information integration system (4) for analytical judgment to check whether the set value is exceeded, so as to decide whether or not to give a warning signal, wherein the data acquisition monitoring system (41) comprises a remote office system, a production control system, a weaving command information system, a production preparation order monitoring system, a quantity detail monitoring system, a false twist extension monitoring system, a dyeing monitoring system, a water quality monitoring system and a quality monitoring management system. When the central information integration system (4) obtains the real-time state information, it is classified by the data acquisition monitoring system (41) to the remote office system, production control system, weaving command information system, production preparation order monitoring system, quantity detail monitoring system, false twist extension monitoring system, dyeing monitoring system, water quality monitoring system and quality monitoring management system for data display or data analysis, the data are stored in the Cloud database (6) and sent to the end device (5) simultaneously. If the analytical data exceed the set value, the wireless signal transmitting equipment sends the warning signal to each end device (5), so that the supervisor or operator can respond instantly and make corresponding solving processes.

Although the invention has been explained in relation to its preferred embodiment, it is to be understood that many other possible modifications and variations can be made without departing from the spirit and scope of the invention as hereinafter claimed.

To sum up, the embodiment of the present invention can achieve the expected effect, the disclosed specific structure is not yet seen in like products, or disclosed before application, it has met the specification and requirement of patent law, hereby the application for utility patent is proposed according to law for your review and approval, thank you.

1. A Cloud real-time textile intelligent production information management monitoring and prewarning integrated system, comprising a plurality of sensing devices, installed on textile automation equipments to detect the real-time state information of the textile automation equipments;
a plurality of communication systems, connected to the plurality of sensing devices;
at least a server host, connected to the plurality of communication systems, so that the real-time state information detected by the plurality of sensing devices is sent by the plurality of communication systems to the server;
a central information integration system, comprising a server client-side connected to the server host and a data acquisition monitoring system, which can receive and analyze the real-time state information from the server host and judge whether the real-time state information exceeds the set value or not, and generate an analytic data;
a Cloud database, connected to the central information integration system, the real-time state information and analytical data of the central information integration system can be obtained at any time, and the real-time state information is stored in the Cloud database;
at least an end device, which is connected to the central information integration system, it can access and display the real-time state information and analytical data of the central information integration system.

2. The system defined in claim 1, wherein the plurality of sensing devices include a production equipment sensing device, which is installed on the textile automation production equipment to sense the real-time state information of the textile automation production equipment; a dyeing equipment sensing device, which is installed on the textile dyeing equipment to sense the real-time state information of the textile dyeing equipment; a recovery sensing device installed on the reclaimer to sense the real-time state information of reclaimer; an effluent sensing device installed on the effluent treatment equipment to sense the real-time state information of the textile effluent treatment equipment.

3. The system defined in claim 1, wherein the data acquisition monitoring system is connected to the Cloud database, comprising a remote office system, a production control system, a weaving command information system, a production preparation order monitoring system, a quantity detail monitoring system, a false twist extension monitoring system, a dyeing monitoring system, a water quality monitoring system and a quality monitoring management system, so that the data acquisition monitoring system can collect and identify different kinds of textile real-time state information, if the set value is exceeded, a warning signal is sent to the end device, and the real-time state information is stored in the Cloud database.

4. The system defined in claim 1, wherein the analytical data comprises a warning signal data, so that the warning signal data can be sent by the central information integration system and displayed on the end device.
